(19) United States
(12) Patent Application Publication
(10) Pub. No.: US 2024/0399642 A1
(43) Pub. Date: Dec. 5, 2024

(54) Method and apparatus for forming plastic preforms into plastic containers with four pressure levels and bottom cooling

(71) Applicant: KRONES AG, Neutraubling (DE)

(72) Inventors: Markus KULZER, Zell (DE); Dominik MEIER, Parsberg (DE); Daniel VOGLER, Neutraubling (DE); Benedikt HENGL, Essing (DE)

(21) Appl. No.: 18/732,507

(22) Filed: Jun. 3, 2024

(30) Foreign Application Priority Data
Jun. 2, 2023 (DE) 102023114612.2

(51) Int. Cl. B29C 49/06; B29C 49/12; B29C 49/36; B29C 49/42; B29L 31/00

(52) U.S. Cl. CPC B29C 49/06; B29C 49/12; B29C 49/36; B29C 49/42855; B29L 2031/712

(57) ABSTRACT

A method and device for forming plastic preforms into plastic containers has a plurality of forming stations each having application devices which apply a flowable medium at least a first pressure level, a second pressure level, a third pressure level and a fourth pressure level respectively, wherein the second pressure level is higher than the first pressure level, the third pressure level is higher than and the second pressure level and the fourth pressure level is higher than the third pressure level and wherein at least at times a bottom area of the plastic preform and/or plastic container is applied with the flowable medium.

### BACKGROUND OF THE INVENTION

The present invention relates to a method and an apparatus for forming plastic preforms into plastic containers. Such methods and apparatuses have long been known from the prior art. Plastic preforms are usually applied with a flowable medium and in particular with compressed air in order to be formed into plastic containers and in particular plastic bottles.

A wide variety of apparatuses and methods are known in the prior art. It is known in the prior art to apply a plurality of different compressed air levels to the plastic preforms. It is known that plastic preforms are applied with a pre-blowing pressure (hereinafter referred to as P1), an intermediate blowing pressure (hereinafter referred to as Pi1) and a final blowing pressure (hereinafter referred to as P2).

It is also known from the applicant's internal prior art to provide a further intermediate blowing pressure level, which is preferably greater than the intermediate blowing pressure level Pi1 and preferably less than the final blowing pressure level P2. This further pressure level is referred to below as Pi2.

On the one hand, this application of a total of four blowing pressure levels has proven successful, but on the other hand, the shaping of the container bottoms in particular causes difficulties. As there is sometimes insufficient time available for this.

For certain methods, it is also necessary to provide additional container cooling in the blow molding machine. This procedure is partly in conflict with the recovery of blown air.

The object of the present invention is therefore to improve the blow molding of containers in such a manner in which a total of at least four pressure levels are to be used.

### SUMMARY OF THE INVENTION

In a method according to the invention for forming plastic preforms into plastic containers, a transport device transports the plastic preforms along a predetermined transport path, wherein the transport device has a rotatable transport carrier on which a plurality of forming stations for forming the plastic preforms into the plastic containers is arranged, wherein the forming stations each have a stretching rod, with which the plastic preforms are stretched in their longitudinal direction, comprise application devices (in particular blowing nozzles) which apply the plastic preforms with the flowable medium, and wherein the apparatus has at least four reservoirs which store the flowable and in particular gaseous medium and the plastic preforms being applied for their expansion with at least a first pressure level stored in the first pressure reservoir, a second pressure level stored in the second pressure reservoir, a third pressure level stored in the third pressure reservoir and with a fourth pressure level stored in the fourth pressure reservoir, wherein preferably the second pressure level is higher than the first pressure level, the third pressure level is preferably higher than the second pressure level and the fourth pressure level is higher than the third pressure level and wherein at least at times a bottom area of the plastic preform and/or plastic container is applied with the flowable medium and/or such an application takes place, in particular through the stretching rod (or the rod-like body).

It is therefore proposed that, on the one hand, at least four pressure levels are provided to apply the plastic preforms and, in addition, a cooling of a bottom area is carried out and, in particular, an application with the flowable medium.

The first pressure level is also referred to below as the pre-blowing pressure. The second pressure level is a first intermediate blowing pressure level, the third pressure level is a second intermediate blowing pressure level and the fourth pressure level is a final blowing pressure or a final blowing pressure level.

The provision of a further intermediate blowing pressure stage, in this case the second, has advantages in terms of energy efficiency. However, this further pressure stage can mean that there is no longer a sufficient cooling effect during the high-pressure phase because this high-pressure phase, i.e. the time during which the P2 pressure is applied, is comparatively short. The invention thus proposes a procedure that enables sufficient cooling of the container bottom even when four pressure levels are used.

In a preferred method, the bottom area of the plastic preform or the container already formed at this point is applied by a further, fifth pressure reservoir and/or by a pressure level stored in a fifth pressure reservoir. Preferably, valve arrangements or valve blocks of the individual forming stations are connected to this pressure reservoir, so that this further pressure reservoir enables a bottom cooling for each forming station.

In a further preferred method, compressed air is returned at least at times from the expanded plastic container or the expanded plastic preforms and/or the relevant forming stations to at least one pressure reservoir.

This method describes recycling of the compressed air, which also helps to save compressed air. Preferably, this compressed air recycling takes place in those reservoirs that have a lower pressure level.

In a further preferred method, at least one forming station is applied with compressed air from a certain pressure reservoir in a first predetermined time period and compressed air is returned to this pressure reservoir from a further forming station in a second predetermined time period, wherein the first and second time periods cannot be synchronized with one another.

In some methods known from the prior art, synchronization is carried out here. While a certain forming station takes compressed air from a certain pressure reservoir, for example an intermediate blowing pressure reservoir, a further forming station fills compressed air into this pressure reservoir at exactly the same time or compressed air flows into this pressure reservoir (in particular during recycling). This is understood as synchronous in the context of the invention. In the context of the invention, however, it is proposed that precisely such a synchronization is not made possible.

In this description, the terms pressure reservoir and reservoir are used synonymously.

Particularly preferably, the application of plastic preforms with compressed air from a predetermined pressure reservoir is not synchronized with the return of compressed air to this pressure reservoir. In machines known from the prior art, there is an option with which this synchronization can be selected. The plastic preforms are applied with compressed air from a certain pressure reservoir in a certain situation and compressed air is fed back into this pressure reservoir from another station in the same period of time.

Particularly preferably, the predetermined pressure reservoir is the second or the third pressure reservoir, i.e. in particular those pressure reservoirs that store the above-mentioned intermediate blowing pressures Pi1 and Pi2.

By default, these intermediate blowing pressures PI1 and PI2 are controlled asynchronously. The option to control Pi1 or Pi2 synchronously could still be selected in BkiR mode (bottom cooling in series) but is not recommended. Both intermediate blowing stages can remain active in this case, which is favorable for air consumption, but the high-pressure phase is largely retained.

In a further preferred method, the plastic preforms are stretched in their longitudinal direction by a stretching rod. In this method, the individual forming stations each have stretching rods that can be inserted into the plastic preforms in order to stretch them in their longitudinal direction.

Preferably, the bottom of the plastic preforms or plastic containers is applied and/or cooled through this stretching rod.

A further pressure level is preferably used for this purpose. The bottom is preferably not formed by this further pressure level, but merely cooled. At a time when the second pressure is applied, the bottom is preferably finally formed. The next pressure level comes at the same time or with a time delay, but no longer actively forms, but only cools. Cooling is preferably based on a pressure gradient P3→P2.

In a further preferred method, the application of the plastic preform with the fourth pressure level, i.e. the P2 pressure level, and the application of the bottom area with the further pressure level (hereinafter referred to as P3) is carried out or begins within a predetermined time interval from P2, wherein this time interval is less than 100 ms, preferably less than 60 ms, preferably less than 40 ms and preferably less than 30 ms.

In this method, it is proposed that the application of the bottom area with a predetermined pressure, hereinafter referred to as P3, starts substantially parallel (or simultaneously) to P2. To further increase the cooling time, it is possible to set the start time after P2 to 0 ms. In this case, P3 starts directly with P2. A slightly negative value would even be conceivable, provided the process allows it (up to the time periods mentioned above).

Due to the greater pressure drop, more expansion cooling is converted. The cooling effect increases in this manner. Preferably, however, the difference in cross-section between the pressure levels P2 and P3 is still large enough that the air flowing through the stretching rod or cooling rod does not significantly influence the forming process.

The flow rate of the flowable medium that reaches the bottom area (P3) is particularly preferably equal to the flow rate of the flowable medium that is supplied under the final blowing pressure P2. Preferably, the flow rate of the flowable medium that enters the container under pressure P2 is at least twice as large, preferably at least four times as large, preferably at least 10 times as large as the flow rate that reaches the bottom area under pressure P3.

In a further preferred method, recycling is also asynchronous in the first pressure stage, i.e. in the P1 pressure level. Synchronized recycling can also be selected here as an option. Optionally, this recycling stage can also be completely deactivated, i.e. in this case there is no recycling to the first pressure stage P1. Depending on requirements, the high-pressure phase, i.e. the application of pressure P2 and/or the cooling phase with pressure P3, can be extended or, if controllable, shortened, in particular in favor of improved air consumption.

In a further preferred method, an intermediate blowing pressure control is used and in particular an intelligent intermediate blowing pressure control. If this is in a phase 1, the final blowing pressure P2 begins with an original start value of Pi1 and P3 with the original start value of P2. In this special case, a possible start value is preferably ignored so that the bottom cooling in series does not switch immediately after P1, as it can no longer be ruled out with certainty that the BKIR air influences the material distribution. Preferably, intermediate blowing stages are not switched during the forming of the container and the second pressure level follows directly after the first pressure level P1.

Particularly preferably, the bottom area is applied in such a manner that the actual expansion or blowing process of the containers is not noticeably impaired.

The invention ensures that the bottom cooling or bottom cooling in series can also be used to its full extent with an additional intermediate blowing stage and a new blowing process.

The present invention is further directed to an apparatus for forming plastic preforms into plastic containers, which has a transport device which transports the plastic preforms along a predetermined transport path, wherein the transport device has a rotatable transport carrier on which a plurality of forming stations for forming the plastic preforms into the plastic containers is arranged, wherein the forming stations each have a stretching rod with which the plastic preforms are stretched in their longitudinal direction and/or are stretchable and wherein the forming stations each have application devices which apply the plastic preforms with the flowable medium and wherein the apparatus has at least four pressure reservoirs which store the flowable and in particular gaseous medium and the plastic preforms can be applied with at least a first pressure level stored in the first pressure reservoir, a second pressure level stored in the second pressure reservoir, a third pressure level stored in the third pressure reservoir and a fourth pressure level stored in the fourth pressure reservoir, wherein the second pressure level is higher than the first pressure level and the third pressure level is higher than the second pressure level and the fourth pressure level is higher than the third pressure level and wherein the apparatus has a bottom application device which is suitable and intended for applying (and/or cooling) the bottoms of the plastic preforms or plastic containers with the flowable medium during the expansion process, wherein a bottom area of the plastic preform and/or plastic containers is and/or can be applied preferably at least at times with the flowable medium.

In particular, the bottom application device is suitable and intended for applying the bottoms of the plastic preforms with compressed air from the inside, i.e. from the interior space of the plastic preforms.

In a further preferred embodiment, the apparatus has a compressed air supply device that provides compressed air. Furthermore, a distribution device and, in particular, a rotary distributor is provided with which the compressed air can be distributed from a in particular stationary pressure source or the pressure supply device to the pressure reservoirs or the ring channels.

Preferably, the pressure reservoirs are ring channels, which are particularly preferably arranged on the above-mentioned rotatable carrier.

In a further advantageous embodiment, the apparatus has a plurality of pressure measuring devices which measure the pressures at individual areas of the apparatus, in particular in the aforementioned pressure reservoirs and/or in particular also in the individual forming stations.

In addition, the apparatus preferably has flow measuring devices which are suitable and intended for determining a flow rate of air and in particular blown air.

Particularly preferably, the apparatus has a regulating device for the pressure reservoirs, in particular for the first and fourth pressure reservoirs. This control can be a so-called dome pressure regulator, for example.

In a further advantageous embodiment, the forming stations each have stretching rods which stretch the plastic preforms in their longitudinal direction during their expansion, wherein preferably these stretching rods have channels through which the gaseous medium can be guided to the bottom portions of the plastic preforms or plastic containers.

In a further advantageous embodiment, the apparatus has a further pressure reservoir which is suitable and intended for applying the plastic preforms with a further pressure level and/or for applying the bottom areas of the plastic preforms or plastic containers. As mentioned above, this pressure level is also referred to below as P3.

In this embodiment, the apparatus preferably has at least five pressure reservoirs.

In a further advantageous embodiment, compressed air can be fed from the plastic containers into at least one pressure reservoir. Particularly preferably, compressed air can be fed from the plastic containers into at least the second and/or third pressure reservoir, i.e. the intermediate pressure reservoirs. This can be achieved in particular by switching the valves of the individual forming stations accordingly. Preferably, a return from the pressure level P3, which is used to cool the bottoms, to the pressure reservoir with the pressure P2 is also possible (from P3 via the container into P2).

Preferably, the apparatus has a control device which controls both the application of the different pressure levels to the plastic preforms and the return of compressed air to the individual pressure reservoirs.

Preferably, this control device is designed in such a manner that synchronization between the application of the plastic preforms in a first forming station and the return of compressed air to the pressure reservoirs (by a second forming station) is prevented and preferably always prevented.

In a further advantageous embodiment, the compressed air can also be fed into the first pressure reservoir, i.e. the pressure reservoir for the P1 pressure.

Preferably, at least one forming station can be supplied with compressed air from a certain pressure reservoir in a first predetermined time period and, starting from a further forming station, compressed air can be supplied to this (certain) pressure reservoir in a second predetermined time period, wherein the first and second time periods are not synchronisable and/or are not synchronized with one another.

In a further preferred embodiment, the application of plastic preforms with compressed air from a predetermined pressure reservoir is not synchronisable and/or is not synchronized with the return of compressed air to this pressure reservoir.

In a further preferred embodiment, the predetermined pressure reservoir is the second pressure reservoir or the third pressure reservoir.

### BRIEF DESCRIPTION OF THE DRAWINGS

Additional advantages are found in the accompanying drawings. In the drawings:

FIG. 1 shows a schematic view of an apparatus according to the invention; and

FIG. 2 shows a representation of pressure curves.

### DETAILED DESCRIPTION OF THE INVENTION

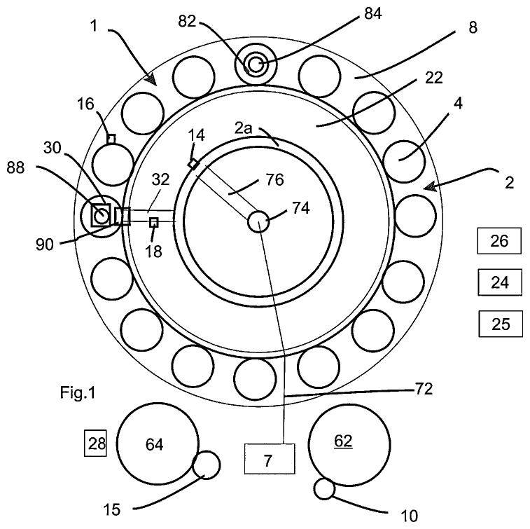

FIG. 1 shows an apparatus 1 for forming plastic preforms 10 into plastic containers 15. This apparatus has a rotatable carrier 22 on which a plurality of forming stations 4 are arranged. These individual forming stations each have blow-molding devices 82, which in their interior form a cavity for expanding the plastic preforms.

The reference sign 84 denotes an application device, which is used to expand the plastic preforms 10. This can be a blowing nozzle, for example, which can be applied to a mouth of the plastic preforms in order to expand the latter. In addition, it is also conceivable to seal the blowing nozzle on the blow-molding device. Preferably, this application device is movable in a longitudinal direction, and preferably exclusively in a longitudinal direction of the plastic preforms.

Reference sign 90 denotes a valve arrangement, such as a valve block, which preferably has a plurality of valves that control the application of different pressure levels to the plastic preforms. Each forming station preferably has such a valve block.

In a preferred method, the plastic preforms are initially applied with a pre-blowing pressure P1, subsequently with at least one intermediate blowing pressure Pi, and finally with a final blowing pressure P2 which is higher than the intermediate blowing pressure Pi1. Particularly preferably, the plastic preforms are applied with a further intermediate blowing pressure Pi2 which is greater than the pressure Pi1, but smaller than the pressure P2. However, it would also be possible to apply only the pre-blowing pressure P1 and the final blowing pressure.

After expansion of the plastic containers, the pressures or compressed air are preferably returned from the container to the individual pressure reservoirs.

The reference sign 88 denotes a stretching rod used to expand the plastic preforms in their longitudinal direction. Preferably, all forming stations have such blow molds 82 and stretching rods 88. This stretching rod is preferably a component of a stretching device denoted by 30. The stretching rod is (preferably, also exclusively) movable in the longitudinal direction of the plastic preforms 10.

Preferably, the number of such forming stations 4 is between 2 and 100, preferably between 4 and 60, preferably between 6 and 40.

The plastic preforms 10 are fed to the apparatus via a first transport device 62 such as, particularly but not exclusively, a transport starwheel. The plastic containers 15 are transported away via a second transport device 64.

The reference sign 7 denotes a pressure supply device, such as a compressor or also a compressed-air connection. The compressed air is conveyed via a connecting line 72 to a rotary distributor 74 and from there passed on via a further line 76 to the pressure reservoir 2a, which in this case is an annular channel. Thus, preferably, such rotary distributor serves the purpose of feeding air from a stationary part of the apparatus into a rotating part of the apparatus.

In addition to such annular channel 2a shown, further annular channels are preferably provided, which are, however, concealed by, e.g., lie underneath, the annular channel 2a in the illustration shown in FIG. 1. Thus, there is preferably one pressure reservoir each for storing the pressure P2 and the intermediate blowing pressures Pi1 and Pi2. In addition, a further pressure reservoir is also preferably provided to store the pressure P3, which is used to cool the bottom of the container.

The reference numeral 32 indicates a connecting line which delivers the compressed air to a forming station 4 or its valve block 90. Preferably, each of the annular channels is connected to all forming stations via corresponding connecting lines. Such connecting line is preferably arranged in the rotating part of the apparatus.

The reference numeral 8 schematically identify an optional clean room, which is preferably designed here in the shape of a ring and surrounds the transport path of the plastic preforms 10. Preferably, a (geometric) axis of rotation with respect to which the transport carrier 22 is rotatable is arranged outside the clean room 8. Preferably, the clean room is sealed from the non-sterile environment by a sealing device, which preferably has at least two water locks.

Furthermore, the apparatus has a cover device (not shown in FIG. 1), which delimits the clean room 8 upward. This cover device is preferably arranged on at least one of the stretching devices 30.

The apparatus has a plurality of measuring and/or sensor devices which serve to control the apparatus. The reference sign 14 designates a pressure-measuring device which measures an air pressure within the pressure reservoir 2a. The other pressure reservoirs also preferably have corresponding pressure-measuring devices.

The reference sign 16 denotes a further pressure-measuring device which measures an air pressure—in particular, a container interior pressure of the plastic preform to be expanded. Preferably, such a pressure-measuring device is assigned to each forming station.

The reference numeral 18 also schematically identify a flow measuring device, which determines a flow rate of the blowing air from a pressure reservoir to the valve block 90 of a forming station 4. Preferably, corresponding flow measurement devices are arranged between a pressure reservoir and all forming stations.

However, it is particularly preferable to only measure the high-pressure air and possibly the low-pressure air, in order to save on measurement technology, it is sufficient to know what quantity of air is supplied to the machine.

Further flow measurement devices can also be assigned between the further pressure reservoirs and the respective forming stations.

Furthermore, position-detection devices are preferably also provided which can detect positions of the stretching rods of the individual forming stations.

The reference numeral 24 indicates a control device which controls and in particular regulates the apparatus 1. This control device is preferably also able to change working parameters of the apparatus.

The control device accordingly controls in particular the individual valves and hence the application to the plastic preforms of the individual pressure levels. In addition, the control device preferably also controls a movement of the stretching rods of the individual forming stations. Preferably, the control device also controls movements of the application devices, i.e. the blowing nozzles. The control device is therefore preferably suitable for controlling the points in time at which the application devices are applied to the plastic preforms and/or the points in time at which the blow-molding devices are again lifted from the plastic preforms, and in particular also for changing these points in time.

The reference sign 26 denotes a memory device in which in particular measured variables are detected—in particular, pressure values and flow values, but also corresponding working parameters. Preferably, these respective values are stored with a temporal assignment.

These values can preferably be stored continuously and in particular over long periods of machine operation. The control device controls or regulates the apparatus, also taking into account these recorded measured values.

Reference numeral 28 roughly schematically identifies an inspection device for inspecting the finished containers.

The reference sign 25 denotes a display device which serves to output information to a machine operator. By this display device, measured pressure (characteristic) curves can be output, for example.

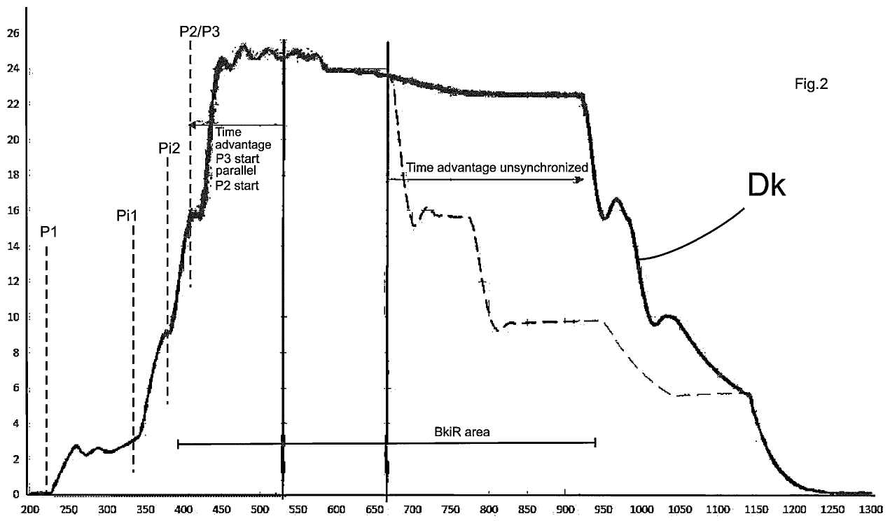

FIG. 2 shows a course of a pressure curve Dk during the forming of a plastic preform into a plastic container. Two intermediate blowing pressure levels are used here. It can be seen that the plastic preforms here are applied with four pressure levels (P1, Pi1, Pi2, P2) and an additional pressure level P3 for bottom cooling.

As mentioned above, it would be desirable to extend the effective part of the application with the P2 pressure level over time as far as possible.

By starting the P2 and P3 pressure levels in parallel, the phase in which the final blowing pressure is applied can be increased as shown in the figure (the arrow pointing to the left).

The non-synchronous controlling described above can be used to increase the phase in which the final blowing pressure is applied, as also shown in FIG. 2 (the arrow pointing to the right).

The dashed curve shows the pressure curve when synchronicity is selected.

Preferably, the P2 pressure level is a setpoint value (resulting from the force required to form the container). The amount of air consumed depends on the shape and pressure of the bottle after Pi2 phase.

P3 preferably opens with a time delay or alternatively parallel to P2 and always has a higher pressure level. The pressure difference is preferably between 0 and 40 bar, preferably between 2 and 10 bar and particularly preferably between 3 and 5 bar.

Since P3 and P2 (i.e. the valves assigned to these pressure levels) are open “over long distances” (depending on the start) in parallel (or simultaneously) and there is an overpressure of P3, air flows from P3 (i.e. the pressure reservoir which holds the pressure level P3) via the container into P2 and thus refills the P2 channel.

P3 is regulated preferably. Ideally, the pressure reservoir P3 pumps up the pressure reservoir P2 completely, i.e. the totality of the demand for demolding P2 is pushed back into P2 via P3 and a predecessor container.

How much air can flow through this system in P2 depends on the differential pressure (P3−P2) (control variable) of the cross-sectional bore of the cooling rod or stretching rod and the duration of this recirculation.

The cross-sectional bore or its cross-section is geometrically limited and is preferably between 2 mm and 4 mm.

The differential pressure is preferably controlled (more time less differential pressure; less time=higher differential pressure). In the vast majority of use cases, the pressure regulates to the upper limit because the 4 bore and the process time P2 can simply almost never be completely filled. The upper limit is variable and could theoretically be raised up to the compressor pressure without any energy disadvantage. In practice, however, compressor pressure is often adjusted to P2, so a maximum differential pressure of 5 bar is aimed for. The aim is to ensure that the cooling effect is sufficient even with a differential pressure of 5 bar.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for forming plastic preforms into plastic containers wherein a transport device transports the plastic preforms along a predetermined transport path, wherein the transport device has a rotatable transport carrier on which a plurality of forming stations for forming the plastic preforms into the plastic containers is arranged, wherein the forming stations each have a stretching rod with which the plastic preforms are stretched in their longitudinal direction and each have application devices which apply the plastic preforms with the flowable medium and wherein the apparatus has at least four pressure reservoirs which store the flowable medium and the plastic preforms are applied for their expansion with at least a first pressure level stored in the first pressure reservoir, a second pressure level stored in the second pressure reservoir, a third pressure level stored in the third pressure reservoir and a fourth pressure level stored in the fourth pressure reservoir, wherein the third pressure level is higher than the second pressure level and the fourth pressure level is higher than the third pressure level and wherein at least at times a bottom area of the plastic preform and/or plastic container is applied with the flowable medium through the stretching rod.

2. The method according to claim 1,
wherein
the bottom area is applied with a further pressure level stored in a fifth pressure reservoir.

3. The method according to claim 1,
wherein
at least at times, compressed air is fed back from the expanded plastic container into at least one pressure reservoir.

4. The method according to claim 1,
wherein
at least one forming station is applied with compressed air from a certain pressure reservoir in a first predetermined time period and compressed air is returned to this pressure reservoir from a further forming station in a second predetermined time period and the first and second time periods cannot be synchronized with one another.

5. The method according to claim 1,
wherein
the application of plastic preforms with compressed air from a predetermined pressure reservoir is not synchronized with the return of compressed air to this pressure reservoir.

6. The method according to claim 5,
wherein
the predetermined pressure reservoir is the second pressure reservoir or the third pressure reservoir.

7. The method according to claim 2,
wherein
the application of the plastic preform with the fourth pressure level and the application of the bottom area with the further pressure level begin within a predetermined time interval, wherein this time interval is less than 100 ms.

8. An apparatus for forming plastic preforms into plastic containers with a transport device which transports the plastic preforms along a predetermined transport path, wherein the transport device has a rotatable transport carrier on which a plurality of forming stations for forming the plastic preforms into the plastic containers is arranged, wherein the forming stations each have a stretching rod with which the plastic preforms are stretched in their longitudinal direction and have application devices which apply the plastic preforms with the flowable medium and wherein the apparatus has at least four pressure reservoirs which store the flowable medium and the plastic preforms can be applied with at least a first pressure level stored in the first pressure reservoir, a second pressure level stored in the second pressure reservoir, a third pressure level stored in the third pressure reservoir and a fourth pressure level stored in the fourth pressure reservoir, wherein the second pressure level is higher than the first pressure level and the third pressure level is higher than the second pressure level and the fourth pressure level is higher than the third pressure level and wherein the apparatus has a bottom application device which is suitable and intended for applying the bottoms of the plastic preforms and/or plastic containers with the flowable medium during the expansion process.

9. The apparatus according to claim 8,
wherein
the apparatus has a further fifth pressure reservoir which is configured for applying the plastic preforms with a further pressure level and/or for applying the bottom areas of the plastic preforms or plastic containers.

10. The apparatus according to claim 8,
wherein
compressed air can be fed from the plastic containers into at least one reservoir.

11. The apparatus according to claim 8,
wherein
at least one forming station can be applied with compressed air from a certain pressure reservoir in a first predetermined time period and compressed air can be supplied to this pressure reservoir from a further forming station in a second predetermined time period and the first and second time periods are not synchronisable and/or are not synchronized with one another.

12. The apparatus according to claim 8,
wherein
the application of plastic preforms with compressed air from a predetermined pressure reservoir is not synchronisable and/or is not synchronized with the return of compressed air to this pressure reservoir.

13. The apparatus according to claim 12,
wherein
the predetermined pressure reservoir is the second pressure reservoir or the third pressure reservoir.
